(19) United States
(12) Patent Application Publication
(10) Pub. No.: US 2003/0176573 A1
(43) Pub. Date: Sep. 18, 2003

(54) Metallized unsaturated polymer anions, stabilized by a coordinate bond and having a large portion of cis double bonds

(76) Inventors: Michael Grun, Siegburg (DE); Thomas Knauf, Dormagen (DE); Wilfried Braubach, Solingen (DE)

Correspondence Address: Bayer Corporation, Patent Department, 100 Bayer Road, Pittsburg, PA, 15205-9741, US

(21) Appl. No.: 10/362,200

(22) PCT Filed: Aug. 10, 2001
(86) PCT No.: PCT/EP01/09254

(30) Foreign Application Priority Data
Aug. 23, 2000 (DE) 10041195.9

(51) Int. Cl. C08G 63/48; C08G 63/91; C07F 1/02

(52) U.S. Cl. 525/69; 260/665 R

(57) ABSTRACT

The invention relates to metallized, unsaturated polymer anions stabilized by coordinate bonding and having a high proportion of cis double bonds, to a process for the preparation thereof and also to the use of the new polymer anions for the preparation of graft polymers that can be obtained by reaction of the unsaturated polymer anions with anionically polymerisable, non-polar monomers. From the graft polymers that are prepared in this way the most diverse rubber mouldings can be produced by appropriate vulcanization processes.

The invention relates to metallized, unsaturated polymer anions stabilized by coordinate bonding and having a high proportion of cis double bonds, to a process for the preparation thereof and also to the use of the new polymer anions for the preparation of graft polymers that can be obtained by reaction of the unsaturated polymer anions with anionically polymerisable, non-polar monomers. From the graft polymers that are prepared in this way the most diverse rubber mouldings can be produced by appropriate vulcanization processes.

In principle, it is known to metallize polymers that contain activated hydrogen atoms by causing such polymers to react, for example, with alkali metals or with organic alkali-metal compounds, in particular organolithium compounds such as butyllithium, in the presence of complex-forming compounds such as alkali-metal alkoxides, alkali-metal phenoxides, tertiary polyamines or crown polyethers. Such metallization reactions for polymers containing activated hydrogen atoms and based on, for example, conjugated dienes or copolymers based on such conjugated dienes and vinyl-aromatic compounds such as styrenes or based on ethylene, propylene and non-conjugated dienes such as hexadienes, dicyclopentadienes or ethylene norbornenes (EPDM) are described, for example, in U.S. Pat. No. 3,781,262, U.S. Pat. No. 3,925,511, U.S. Pat. No. 3,978,161, U.S. Pat. No. 4,761,456, U.S. Pat. No. 5,652,310 as well as EP-A 0 942 004 and Houben-Weyl: Methoden der Organischen Chemie, 4th Edition, Volume E20, Makromolekulare Stoffe pp 129 ff and 1994 ff, Georg-Thieme Verlag Stuttgart, New York, 1987.

From the cited publications it is known, moreover, that the metallized polymers or polymer anions serve, for example, for the preparation of graft polymers that are obtained by reaction with suitable polymerisable monomers.

From GB 1 173 508 A it is known to prepare polymers bearing high-molecular reactive groups by causing a homopolymer of a conjugated C₄-C₉ diolefin (1,3-butadiene, isoprene), a copolymer of such a diolefin with a monovinyl-aromatic compound (styrene) or a mixture thereof to react with an alkali metal or with an organoalkali compound (or a mixture thereof, especially a lithium compound or an organolithium compound) in the presence of a defined tertiary amine. In the presence of the stated amines it is possible for active alkali residues to be introduced into the polymer while maintaining the double bond. According to the named patent publication, the polymers containing active alkali residues may be used for preparing graft copolymers, for preparing high-molecular cross-linked polymers using polyfunctional compounds or for preparing polymers with functional groups by reaction with functional compounds, for example carbon dioxide, from which it is possible for fibres, resins and elastomers to be produced in turn (cf also Hochmolekularbericht 1970, report H 7686/79).

Preparation of the homopolymers or copolymers is effected in accordance with GB 1 173 508 A by ionic (anionic or cationic) polymerisation or radical polymerisation. In this case the polymerisation may—as previously described—be carried out, for example, in the presence of alkali metals or alkali-metal compounds or in the presence of Ziegler-Natta catalysts that comprise alkali compounds or hydrides of elements pertaining to Groups 1, II and III of the Periodic Table of the Elements and halides, alcoholates and acetonates of the transition metals pertaining to Groups IV, V and VI.

The metallized polymers or polymer anions that are prepared by anionic polymerisation have the disadvantage that only the properties of anionically polymerised polymers are combined with one another and adjustment of the microstructure is possible only within the context of anionic polymerisation. With this method of preparation it is, for example, not possible to obtain a polymer with a high cis content in which the cis-1,4 content lies above 50%.

The polymer anions that are obtained in accordance with United Kingdom patent application GB 1 173 508 A possess a cis-1,4 content of about 92%. Even this cis-1,4 content is still too low for certain physical properties of the vulcanisates produced therefrom.

Now the object of the present invention was to make available metallized, unsaturated polymer anions stabilized by coordinate bonding and having a high proportion of cis double bonds, which are obtained by polymerisation of appropriate unsaturated monomers in the presence of rare-earth-metal catalysts and by a subsequent metallization reaction and which result in an improved impact strength in the case of thermoplastics (e.g. in the case of HIPS and ABS products), which are better able to be mixed into tyre mixtures than the known products and which result in improved physical properties in the case of rubber vulcanizates.

The present invention therefore provides metallized, unsaturated polymer anions stabilized by coordinate bonding and having a high proportion (greater than 92%, preferably greater than 95%, in particular greater than 97%, relative to 100 g of polymer) of cis double bonds, capable of being prepared by polymerisation of unsaturated monomers in the presence of rare-earth metal catalysts, with the proviso that the polymers obtained in this way contain 1.0 to 1000, preferably 1.5 to 100, in particular preferably 2 to 30, mmol of active hydrogen atoms per 100 g of polymer, and by subsequent reaction of the polymers that are obtained with reagents capable of coordinate bonding in the presence of organometallic compounds, the organometallic compounds being employed in quantities from 1.0 to 1000, preferably 1.5 to 100, in particular preferably 2 to 30, mmol per 100 g of polymer.

A hydrogen atom that can be easily substituted by appropriate metals is designated as an active hydrogen atom. Examples of active hydrogen atoms are allylic hydrogen atoms or hydrogen atoms located in the vicinity of electron-attracting groupings.

By way of unsaturated monomers for the preparation of the metallized polymer anions according to the invention, conjugated dienes enter into consideration in particular, such as 1,3-butadiene, isoprenes, piperylene, 1,3-hexadiene, 1,3-octadiene, 2-phenyl-1,3-butadiene, preferably 1,3-butadiene.

The aforementioned conjugated dienes can, of course, be copolymerised with vinyl-aromatic monomers such as styrenes.

Furthermore, alkenes such as ethylene and propylene can also be employed for the purpose of synthesising the polymers to be metallized, which can be caused to react in known manner optionally with non-conjugated polyenes such as ethylidene norbornene, vinylidene norbornene, dicyclopentadiene, 2-methyl-1,5-hexadiene, 3,3-dimethyl-1,5-hexadiene, 1,6-heptadiene, 1,7-octadiene, 1,8-nonadiene, 1,9-decadiene and/or 1,19-eicosadiene to produce the corresponding terpolymers, such as EPDM, having rubber properties. The proportion of non-conjugated polyenes usually amounts to up to 15 wt. %, the proportion of alkenes is supplemented appropriately to make up 100 wt. %.

The proportion of the vinyl-aromatic monomers that are capable of being copolymerised with the conjugated dienes can amount to up to 40 wt. %. A higher proportion is possible. Said proportion is dependent upon the later intended use of the metallized polymer anions.

In principle, all known monomer units that can be polymerised or copolymerised in the presence of rare-earth-metal catalysts can be employed for the purpose of synthesising the metallized polymer anions according to the invention, with the proviso stated above in respect of the number of active hydrogen atoms.

In the case of copolymerisation, the quantity of monomers to be employed is dependent—as mentioned—in particular upon the later intended use of the polymers and upon the desired properties of the polymers.

To be mentioned in particular are polymer anions that are synthesised as follows: homopolybutadiene with more than 92% cis double bonds, preferably more than 95%, in particular more than 97% cis double bonds; copolymers synthesised from 2 to 98% 1,3-butadiene and a proportion, supplemented appropriately to make up 100%, of a comonomer such as 1,3-isoprene, piperylene, 1,3-hexadiene, 1,3-octadiene or 2-phenyl-1,3-butadiene. Also to be mentioned are copolymer anions synthesised from styrenes (20 to 40%) and 1,3-butadiene (80 to 60%).

As mentioned, the polymerisation of the monomers serving to synthesise the polymers is carried out, in accordance with the invention, in the presence of rare-earth-metal catalysts.

The use of rare-earth-metal catalysts in the course of the polymerisation is important for the metallized polymer anions according to the invention, since only with these catalysts can certain physical properties be achieved that contribute to achieving the object according to the invention.

By way of rare-earth-metal catalysts, compounds of the rare-earth metals are preferably employed, such as cerium, lanthanum, praseodymium, gadolinium or neodymium compounds, that are soluble in hydrocarbons. In particularly preferred manner the corresponding salts of the rare-earth metals are employed as catalysts, such as neodymium carboxylates, in particular neodymium neodecanoate, neodymium octanoate, neodymium naphthenate, neodymium-2,2-diethylhexanoate, neodymium-2,2-diethylheptanoate, as well as the corresponding salts of lanthanum or praseodymium. Quite particularly preferred is neodymium neodecanoate.

The aforementioned rare-earth-metal catalysts are known and are described, for example, in the German patent application having application number 19 951 841.6 and also in DE-A 28 48 964 and DE-A 26 25 390.

In a preferred embodiment the polymerisation of the unsaturated monomers is carried out in the presence of a rare-earth-metal catalyst system, as described in German Patent Application No. 19 951 841.6.

According to the cited German patent application, a catalyst system based on compounds of the rare-earth metals is employed consisting of

a) a compound of the rare-earth metals

b) an organic aluminium compound

c) a trihalosilane of the formula

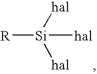

where

hal stands for fluorine, chlorine or bromine and

R signifies hydrogen or a vinyl group,

in which the components a): b): c) are present in a ratio of 1:0.5 to 5:0.05 to 0.5 in anhydrous form (water content: ≦1000 ppm, preferably ≦500 ppm, relative to a 20 wt. % solution of component a) in an inert, aliphatic solvent).

By way of component a) of the aforementioned catalyst system based on compounds of the rare-earth metals, the compounds already mentioned of the rare-earth metals are employed; by way of organic aluminium compound (component b)), in particular aluminium alkyls and aluminium alkyl hydrides enter into consideration in which the alkyl group possesses 1 to 10, preferably 1 to 6, carbon atoms. The aluminium alkyl hydrides may possess one or two alkyl groups. To be named preferably are: triethylaluminium, diisobutylaluminium hydride, triisobutylaluminium; quite particularly preferred is diisobutylaluminium hydride. Trichlorosilane is preferably employed by way of trihalosilane (component c)).

In accordance with the invention, catalyst systems based on compounds of the rare-earth metals, in which the components a): b): c) are preferably present in a weight ratio of 1:1 to 2:0.1 to 0.4 and component a) is neodymium versatate, component b) represents diisobutylaluminium hydride and component c) signifies trichlorosilane.

The metallization of the polymers or elastomers with active hydrogen atoms obtained in this way is subsequently carried out by reaction of these polymers or elastomers with suitable organometallic compounds in the presence of reagents capable of coordinate bonding.

All organometallic compounds known from the state of the art can be employed by way of organometallic compounds for the metallization, including the metals themselves. Alkali metallo-organic compounds or their underlying metals are preferably employed by way of organometallic compound. Very particularly preferred are organolithium compounds that are represented by the formula R-Li, where R symbolises a hydrocarbyl radical, with 1 to 20 C atoms. Such monofunctional organolithium compounds preferably contain 1 to 10 C atoms. The following are named as examples: methyllithium, ethyllithium, isopropyllithium, n-butyllithium, sec-butyllithium, n-octyllithium, tert.-octyllithium, n-decyllithium, phenyllithium, 1-naphthyllithium, 4-butylphenyllithium, p-tolyllithium, 4-phenylbutyllithium, cyclohexyllithium, 4-butylcyclohexyllithium and/or 4-cyclohexylbutyllithium. Preferred are ethyllithium, isopropyllithium, n-butyllithium, sec-butyllithium, n-hexyllithium, tert.-octyllithium, phenyllithium, 2-naphthyllithium, 4-butylphenyllithium and/or cyclohexyllithium. n-butyllithium and/or sec-butyllithium are very particularly preferred.

With a view to stabilizing the metallized polymers or polymer anions, the metallization is carried out in known manner in the presence of reagents capable of coordinate bonding. Such reagents capable of coordinate bonding are likewise known from the state of the art discussed previously.

By way of reagents capable of coordinate bonding, the following enter into consideration, for example: tert. diamines with three saturated aliphatic hydrocarbon residues, cyclic diamines or bridged diamines. To be named, in particular, are tetramethyl ethylenedianine, tetraethyl ethylenediamine, tetradecyl ethylenediamine, tetra-alkyl-1,2-diaminocyclohexane, tetra-alkyl-1,4-diaminocyclohexane, piperazines, N-N′-dimethylpiperazine as well as sparteine or triethylenediamine. Of course, the named amines can be employed individually or in a mixture with one another.

Moreover, the known alkali-metal alkoxides and also the alkali-metal phenoxides or crown polyethers can be employed by way of reagents capable of coordinate bonding. To be named, in particular, are potassium tert.-amyl oxide, sodium tert.-amyl oxide and/or potassium tert.-butyl oxide.

The quantity of reagents capable of coordinate bonding to be employed usually amounts to 0.1 to 8 wt. %, preferably 0.1 to 4 wt. %, relative to 100 g of polymer.

The present invention further provides the preparation of the metallized, unsaturated polymer anions stabilized by coordinate bonding and having a high proportion, described previously, of cis double bonds by unsaturated monomers being polymerised in the presence of rare-earth-metal catalysts, with the proviso that the polymers obtained in this way contain 1.0 to 1000, preferably 1.5 to 100, in particular preferably 2 to 30, mmol of active hydrogen atoms per 100 g of polymer, and by the polymer that is obtained being subsequently caused to react with reagents capable of coordinate bonding in the presence of organometallic compounds, the organometallic compounds being employed in quantities from 1.0 to 1000, preferably 1.5 to 100, in particular preferably 2 to 30, mmol per 100 g of polymer.

The polymerisation of the previously named, unsaturated monomers in the presence of the aforementioned catalysts is usually carried out at temperatures in the range from −30 to 130° C., preferably 20 to 100° C., optionally under elevated pressure (2 to 10 bar).

It is customary to carry out the polymerisation in the presence of inert, aliphatic solvents such as pentanes, hexanes, heptanes or cyclohexane. In the case of these aliphatic solvents, both the straight-chain and the branched isomers thereof enter into consideration. Moreover, use may also be made of aromatic solvents such as benzene, toluene or ethylbenzene. The solvents can be employed both individually and/or in a mixture with one another; the favourable mixing ratio is easy to ascertain by appropriate preliminary tests.

The quantity of solvent in the process according to the invention usually amounts to 1000 to 100 g, preferably 500 to 150 g, relative to 100 g of the total quantity of monomer employed. Of course, it is also possible to polymerise the monomers employed in the absence of solvents. Polymerisation is preferably undertaken in the presence of a solvent.

The polymerisation according to the invention of the unsaturated monomers in the presence of the named catalysts can be carried out up until complete conversion of the monomers employed. Of course, it is also possible to interrupt the polymerisation prematurely, depending on the desired properties of the polymer, for example in the case of the conversion of about 80% of the monomers.

In preferred manner the polymerisation of the unsaturated monomers is carried out up until the quantitative conversion thereof. Quantitative conversion is designated as that conversion at which a maximum quantity of about 5000 ppm, preferably 500 ppm, of residual monomers is still present in the reaction mixture. If the content of residual monomers in the reaction mixture is higher than the stated values, it is advisable to separate the residual monomers, by distillation for example.

In the course of the preparation according to the invention of the unsaturated polymer anions it is possible firstly, in known manner, to isolate, to purify and to process the polymers obtained from the polymerisation of the unsaturated monomers in the presence of the named catalysts and subsequently to subject the isolated polymers in dissolved form to a metallization reaction.

In preferred manner the polymers obtained in accordance with the process according to the invention (polymerisation) are subjected directly, i.e. in situ without isolation of the polymers obtained, to a metallization reaction in the reaction mixture.

In addition, it is a particular advantage if both the polymerisation with the named catalysts and the following metallization reaction are carried out under practically anhydrous conditions, the maximum water content having already been mentioned previously.

The metallization reaction is usually carried out at temperatures in the range from 20 to 200° C., preferably at 40 to 120° C., in the presence of the aforementioned inert solvents.

In accordance with the invention, the rare-earth-metal catalysts are employed in quantities from about 0.001 to 0.5 wt. %, preferably 0.01 to 0.3 wt. %, relative to the quantity of unsaturated monomers present. The most favourable quantity of catalysts to be employed in the given case can easily be ascertained by appropriate preliminary tests.

In quite preferred manner, in accordance with the invention the unsaturated monomers are polymerised in the presence of the previously described catalyst system consisting of

a) a compound of the rare-earth metals

b) an organic aluminium compound

c) a trihalosilane of the formula

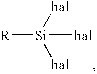

where

hal stands for fluorine, chlorine or bromine and

R signifies hydrogen or a vinyl group,

in which the components a): b): c) are present in a ratio of 1:0.5 to 5:0.05 to 0.5 in anhydrous form (water content: ≦1000 ppm, preferably ≦500 ppm, relative to a 20 wt. % solution of component a) in an inert, aliphatic solvent). In particular, the polymerisation of the unsaturated monomers is carried out with a catalyst system based on neodymium versatate, disiobutylaluminium hydride and trichlorosilane, as likewise already mentioned.

For example, the metallized polymer anions according to the invention can be prepared as follows:

The monomers to be polymerised and the appropriate solvent are submitted in an autoclave provided with a stirring unit, and subsequently the catalyst is added to the solution in metered amounts. The autoclave is previously rendered inert by flushing with an inert gas such as nitrogen. After the desired conversion has been attained, the polymer that is obtained is metallized, in preferred manner in situ, by reaction with reagents capable of coordinate bonding in the presence of the aforementioned organometallic compounds. In the case of the method of working in situ and in the case of an incomplete conversion of monomer, it is an advantage if the unconverted monomers—as already mentioned—are previously, i.e. prior to the metallization reaction, removed from the polymer mixture.

The metallized unsaturated polymer anions that are prepared in accordance with the invention possess a higher content of cis double bonds than the polymer anions obtained in accordance with the state of the art as discussed. Furthermore, they have a comparatively high content of active hydrogen atoms, by virtue of which reactive centres are obtained in the polymer that are capable of further reactions, as described in GB 1 173 508 A, for example. Starting from the unsaturated polymer anions that have been metallized in accordance with the invention having the high proportion, as is described, of cis double bonds and active centres, polymers having improved physical properties can be prepared.

The present invention further provides the use of the metallized polymer anions prepared in accordance with the invention for the preparation of graft polymers.

In this connection the metallized polymer anions are caused to react in known manner with appropriate anionically polymerisable, non-polar monomers such as diolefins, e.g. 1,3-butadiene, 1,3-isoprene, piperylene, and also vinyl-aromatic compounds such as styrene, α-methylstyrene, preferably 1-3-butadiene, 1,3-isoprene, styrene or α-methylstyrene. Of course, it is also possible to employ the named non-polar monomers in mixtures with one another.

The preparation of such graft polymers is generally known and is described, for example, in the previously specified patent publications.

The graft polymers that are produced by reaction of the metallized polymer anions with anionically polymerisable non-polar monomers can serve, in turn, for the production of rubber mouldings of all types, for example for the production of tyres. Furthermore, they can be employed advantageously for the purpose of modifying the impact strength of thermoplastics, for example of HIPS and ABS.

### EXAMPLES

1. Preparation of Polybutadiene Metallized With Lithium

8200 g of n-hexane were submitted into an autoclave which had been flushed with nitrogen and provided with a stirrer. Then 2 mmol of neodymium versatate, 16.7 mmol of diisobutylaluminium hydride and 1.9 mmol of trichlorosilane were added to the submitted hexane, with stirring, and 1800 g of dried, destabilized 1,3-butadiene were added to this mixture in metered amounts. The polymerisation of the 1,3-butadiene was carried out at a temperature of 60° C. up until quantitative conversion of the monomers. The polybutadiene anion that was obtained had a cis-1,4 content of 98.5%.

The polymer that was obtained thereby was directly added—in situ—to 7.5 ml of dried N,N,N′,N′-tetramethyl ethylenediamine and 50 mmol of n-butyllithium, and the mixture was stirred for about 1 hour at a temperature of 100° C.

2. Reaction of the Metallized Polybutadiene Anion with Anionically Polymerisable Monomers (Graft Reaction):

The metallized polybutadiene anion that was obtained in 1) was added to, in each instance, 180 g of dried isoprene, butadiene or styrene and stirred for one hour at 100° C. Then the graft reaction was stopped with ethanol. The graft product that was obtained was stabilized, washed with water and dried at 60° C.

The analysis of the graft polymers that were obtained yielded the following data:

| | | |
|---|---|---|
| a) isoprene grafted: | Mooney: 38 | |
| (Sample a) | 1,4-cis content: | 90.5% |
| | 1,2 content: | 6.8% |
| | 1,4-trans content: | 2.6% |
| | Tg: | −103° C. |
| b) butadiene grafted: | Mooney: 73 | |
| (Sample b) | 1,4-cis content: | 85.9% |
| | 1,2 content: | 9.9% |
| | 1,4-trans content: | 4.2% |
| | Tg: | −102° C. |
| c) styrene grafted: | Mooney: 78 | |
| (Sample c) | 1,4-cis content: | 75.2% |
| | 1,2 content: | 6.6% |
| | 1,4-trans content: | 4.7% |
| | styrene content: | 13.6% |
| | Tg: | −103° C. |

In a further test, the metallized polymer obtained in accordance with 1) or the polymer mixture obtained was cooled to 50° C. To 4.46 kg of the polymer mixture there was charged, in portions, a mixture of 1125 g of 1,3-butadiene, 375 g of styrene and 3.46 mmol of dried divinylbenzene in such a way that the internal temperature of the mixture did not rise above 70° C. After complete conversion of the monomers that were employed, the graft reaction was stopped as described previously and the graft polymer obtained was processed appropriately.

The analysis of the graft copolymer grafted with styrene and butadiene that was obtained yielded the following data (Sample d):

| | |
|---|---|
| Mooney: 67 | |
| 1,4-cis content: | 43.8% |
| 1,2 content: | 23.1% |
| 1,4-trans content: | 16.0% |
| styrene content: | 17.1% |
| Tg: | −63° C. |

3. Preparation of Vulcanizates and Determination of the Physical Properties Thereof

In the case of the vulcanizates it is a question of those such as are employed for tyre-treads, in each instance with carbon black and silica as filler (Tables 2 and 3).

TABLE 1
(Graft polymers employed from the previous samples
and also non-grafted polybutadiene)

| Sample | Grafting | Degree of grafting (%) | ML 1 + 4 |
|---|---|---|---|
| Comparison | without | without | 46 |
| Sample b) | butadiene | 9.5 | 73 |
| Sample c) | styrene | 9.5 | 78 |
| Sample a) | isoprene | 10.6 | 38 |

TABLE 2
Carbon-black mixtures (parts by weight)

| | | | | |
|---|---|---|---|---|
| Natural rubber TSR 5 | 70 | 70 | 70 | 70 |
| Comparison | 30 | | | |
| Sample b) | | 30 | | |
| Sample c) | | | 30 | |
| Sample a) | | | | 30 |
| Carbon black N-330 | 55 | 55 | 55 | 55 |
| Enerthene 1849-1* | 3 | 3 | 3 | 3 |
| Stearic acid | 2.5 | 2.5 | 2.5 | 2.5 |
| Antilux 111** | 1 | 1 | 1 | 1 |
| Vulkanox 4020*** | 2.5 | 2.5 | 2.5 | 2.5 |
| Vulkanox HS/LG**** | 1.5 | 1.5 | 1.5 | 1.5 |
| Zinc oxide RS | 5 | 5 | 5 | 5 |
| Vulkacit NZ/EG***** | 0.9 | 0.9 | 0.9 | 0.9 |
| Sulfur | 2.5 | 2.5 | 2.5 | 2.5 |
| Vulcanizate properties - ISO 37 | | | | |
| Strength (MPa) | 25.2 | 24.7 | 24.6 | 23.9 |
| Elongation at break (%) | 430 | 454 | 451 | 432 |
| Modulus 100 % extension (%) | 3.1 | 2.7 | 2.8 | 3.2 |
| Modulus 300 % extension (%) | 16.1 | 14.1 | 14.4 | 15.3 |
| Tear-propagation resistance (N) | 33.1 | 36.8 | 39.8 | 34 |
| Hardness Shore A 23° C. | 69 | 68.1 | 69.5 | 66 |
| Hardness Shorc A 70° C. | 64 | 64.5 | 65.8 | 63 |
| Rebound elasticity 23° C. (%) | 49 | 49 | 46.7 | 50 |
| Rebound elasticity 70° C. (%) | 60 | 52.1 | 52.7 | 62 |
| DIN abrasion 60 (mm2) | 74 | 80 | 82 | 82 |
| Damping (Rödhlig 10 Hz) DIN 53513 | | | | |
| tan delta -20° C. | 0.366 | 0.375 | 0.372 | 0.426 |
| tan delta 0° C. | 0.23 | 0.21 | 0.213 | 0.23 |
| tan delta 23° C. | 0.186 | 0.167 | 0.173 | 0.18 |
| tan delta 60° C. | 0.142 | 0.125 | 0.147 | 0.134 |

*mineral-oil plasticizer, Mobil Schmierstoff GmbH
**light-screening wax, Rhein Chemie Rheinau
***anti-ageing agent (6PPD), Bayer AG
****anti-ageing agent (TMQ), Bayer AG
*****sulfenamide accelerator (TBBS), Bayer AG
******sulfenamide accelerator (CBS), Bayer AG
*******guanidine accelerator (DPG), Bayer AG
********silica, Bayer AG
*********silane, Degussa

TABLE 3
Silica mixtures

| | | | | |
|---|---|---|---|---|
| Natural rubber TSR 5 | 10 | 10 | 10 | 4 |
| Buna VSL 5025-1 | 61.9 | 61.9 | 37.8 | 61.9 |
| Comparison | 45 | | | |
| Sample b) | | 45 | | |
| Sample c) | | | 62.5 | |
| Sample a) | | | | 51 |
| Enerthene 1849-1* | 20.6 | 20.7 | 27.2 | 20.6 |
| Vulkasil S******** | 70 | 70 | 70 | 70 |
| Silane Si 69********* | 5.6 | 5.6 | 5.6 | 5.6 |
| Stearic acid | 1 | 1 | 1 | 2.5 |
| Antilux 111** | 1.5 | 1.5 | 1.5 | 1 |
| Vulkanox 4020*** | 1 | 1 | 1 | 1.5 |
| Vulkanox HS/LG**** | 1 | 1 | 1 | 1 |
| Zinc oxide RS | 2.5 | 2.5 | 2.5 | 1 |
| Vulkacit CZ/EG****** | 1.8 | 1.8 | 1.8 | 1.8 |
| Vulkacit D******* | 2 | 2 | 2 | 2 |
| Sulfur | 1.5 | 1.5 | 1.5 | 1.5 |
| Vulcanization properties - ISO 37 | | | | |
| Strength (MPa) | 19.8 | 18.3 | 18.7 | 17.8 |
| Elongation at break (%) | 588 | 552 | 593 | 597 |
| Modulus 100 % extension (%) | 2.2 | 2.01 | 2 1.9 | |
| Modulus 300 % extension (%) | 7.4 | 7.4 | 6.6 | 6.6 |
| Tear-propagation resistance (N) | 44 | 87 | 44 | 61 |
| Hardness Shore A 23° C. | 67 | 62 | 59 | 62 |
| Hardness Shore A 70° C. | 65 | 61 | 58 | 59 |
| Rebound elasticity 23° C. (%) | 41 | 40 | 47 | 37 |
| Rebound elasticity 70° C. (%) | 57 | 59 | 59 | 53 |
| DIN abrasion 60 (mm2) | 63 | 87 | 63 | 70 |
| Damping (Röhlig 10 Hz) DIN 53513 | | | | |
| tan delta -20° C. | 0.416 | 0.539 | 0.415 | 0.43 |
| tan delta 0° C. | 0.289 | 0.333 | 0.255 | 0.333 |
| tan delta 23° C. | 0.193 | 0.195 | 0.171 | 0.216 |
| tan delta 60° C. | 0.125 | 0.125 | 0.115 | 0.135 |

Relative to the reference material employed (comparison), which describes the current state of the art, the graft polymers according to the invention are distinguished by excellent processing behaviour. The mechanical properties, such as strength values, modulus values and hardness values, are at the level of the reference material. The tear-propagation resistance values of the polymers according to the invention are improved. Particularly positive is the increase in the dynamic loss angle, tan delta, at low temperatures (−20° C.), which is generally accepted in the industry as an indication of improved wet properties of tyres, and the lowering of the dynamic loss angle at high temperatures (60° C.). This lowering correlates with the rolling resistance of tyres and is all the better, the smaller the loss angle.

The polymers according to the invention are products which can be processed well and with which tyre-treads can be compounded, the properties of which, particularly handling in the wet and/or rolling resistance, are clearly improved in comparison with the state of the art.

1. Metallized, unsaturated polymer anions stabilized by coordinate bonding and having a high proportion of cis double bonds, capable of being prepared by polymerisation of unsaturated monomers in the presence of rare-earth-metal catalysts, with the proviso that the polymers that are obtained in this way contain 1.0 to 1000 mmol of active hydrogen atoms per 100 g of polymer, and by subsequent reaction of the polymers that are obtained with reagents capable of coordinate bonding in the presence of organometallic compounds, the organometallic compounds being employed in quantities from 1.0 to 1000 mmol per 100 g of polymer.

2. Process for preparing metallized, unsaturated polymer anions stabilized by coordinate bonding and having a high proportion of cis double bonds, characterised in that unsaturated monomers are polymerised in the presence of rare-earth-metal catalysts, with the proviso that the polymers that are obtained in this way contain 1.0 to 1000 mmol of active hydrogen atoms per 100 g of polymer, and the polymer that is obtained is subsequently caused to react with reagents capable of coordinate bonding in the presence of organometallic compounds, the organometallic compounds being employed in quantities from 1.0 to 1000 mmol per 100 g of polymer.

3. Use of the metallized polymer anions according to claim 1 for the preparation of graft polymers that are obtained by reaction of the metallized polymer anions with anionically polymerisable, non-polar monomers.

4. Use of the graft polymers according to claim 3 for the preparation of rubber mouldings of all types and also for modifying the impact strength of thermoplastics.
